(19) United States
(12) Patent Application Publication
(10) Pub. No.: US 2014/0019484 A1
(43) Pub. Date: Jan. 16, 2014

(54) Method and Apparatus for Image Searching

(71) Applicants: Benjamin Kenneth Coppin, Cottenham (GB); Mustala Suteyman, London (GB)

(72) Inventors: Benjamin Kenneth Coppin, Cottenham (GB); Mustala Suteyman, London (GB)

(73) Assignee: DeepMind Technologies Limited

(21) Appl. No.: 13/588,097

(22) Filed: Aug. 17, 2012

(30) Foreign Application Priority Data
Jul. 13, 2012 (GB) 12112518.3

(51) Int. Cl. G06F 17/30; G06F 3/048

(52) U.S. Cl. 707/772; 707/E17.016

(57) ABSTRACT

A system and method for creating a search query and for searching based on said search query. A first user selected image and a user selection of a first feature within said first user selected image is received. A second user selected image and a user selection of a second feature within said second user selected image is received. Said first and second user selected features are combined to form a composite image to form the basis of a search query.

### CROSS REFERENCE TO RELATED APPLICATION

The present application claims priority to British Patent Application No. GB1212518.3 entitled “Method and Apparatus for Image Searching”, and filed Jul. 13, 2012. The entirety of each of the aforementioned reference is incorporated herein by reference for all purposes.

### BACKGROUND OF THE INVENTION

This invention relates to a method and apparatus for searching for images, in particular the field known as CBIR (Content based image retrieval) or reverse image searching.

The weakness with traditional image search technologies is that they rely on the user being able to describe what they are searching for in terms of keywords. This works extremely well in some cases (e.g., “photo of Barack Obama”) but is entirely useless when what you are searching for can only be expressed by pointing at an object or another photo, or an abstract idea. CBIR attempts to solve that problem by allowing the user to start a search by supplying an image to search from.

The idea of CBIR is to allow users to search for images based on content rather than by entering keyword queries. The two best known examples of this kind of technology are Google http://www.google.com/insidesearch/features/images/searchbyimage.html and TinEye: http://www.tineye.com/.

Searches based around images are also known in the patent literature. For example, US2012123976 describes methods and systems for object-sensitive image searches. These methods and systems are usable for receiving a query for an image of an object and providing a ranked list of query results to the user based on a ranking of the images. The object-sensitive image searches may generate a pre-trained multi-instance learning (MIL) model trained from free training data from users sharing images at web sites to identify a common pattern of the object.

US2012117051 describes how search queries containing multiple modes of query input are used to identify responsive results. The search queries can be composed of combinations of keyword or text input, image input, video input, audio input, or other modes of input. The multiple modes of query input can be presented in an initial search request, or an initial request containing a single type of query input can be supplemented with a second type of input.

US2012030234 describes a computer-implemented method for generating a search query for searching a source of data. The method comprises: a) receiving image and/or text data; b) extracting one or more search query parameters from the image and/or text data; and c) generating the search query from the or each extracted parameter.

The applicant has recognized the need for an improved searching method and apparatus.

### BRIEF SUMMARY OF THE INVENTION

This invention relates to a method and apparatus for searching for images, in particular the field known as CBIR (Content based image retrieval) or reverse image searching.

According to a first aspect of the invention, there is provided a method of creating a search query comprising:

receiving a first user selected image;

receiving a user selection of a first feature within said first user selected image;

receiving a second user selected image;

receiving a user selection of a second feature within said second user selected image;

combining said first and second user selected features to form a composite image to form the basis of a search query.

According to another aspect of the invention, there is also provided a query engine for creating a search query comprising:

a processor configured to:

receive a first user selected image;

receive a user selection of a first feature within said first user selected image;

receive a second user selected image;

receive a user selection of a second feature within said second user selected image; and

combine said first and second user selected features to form a composite image to form the basis of a search query.

By combining features from two images, the invention allows the user to search from multiple images as well as specifying what exactly it is about an image that they want to search for. By providing this functionality in the query server, an improved apparatus for searching is provided. It will be appreciated that using two images is illustrative and a further user selected image and user selection of a further feature within said further user selected image may be used with said combining step combining all said user selected features to form said composite image.

Once a search query has been formulated, the search query is searched using known techniques. Thus according to another aspect of the invention, there is provided a method of conducting a search comprising forming a search query as described herein, searching for results which match said composite image; outputting said search results to a user; receiving a new user selected image which is selected from within said search results; receiving a new user selection of a feature within said new user selected image; searching for results which match said new user selected feature; and outputting a new set of results.

These tools encourage users to adopt an exploratory search method, where the user starts from one point (perhaps an image they've seen on a web site) and systematically refines their search in a series of steps and possibly through one or more iterations of these series of steps until they find the image or images they are looking for.

It will be appreciated that the iterative nature of the search need not start from a composite image. Thus, according to another aspect of the invention, there is provided method of conducting a search comprising receiving a first user selected image; receiving a user selection of a first feature within said first user selected image; searching for results which match said first selected feature; outputting said search results to a user; receiving a second user selected image which is selected from within said search results; receiving a user selection of a second feature within said second user selected image; and repeating said searching and outputting steps based on said second selected feature. This method may be implemented on a system. According to another aspect of the invention, there is provided a system for conducting a search comprising: a processor which is configured to receive a first user selected image; and receive a user selection of a first feature within said first user selected image; a search engine which is configured to search for results which match said first selected feature; output said search results to a user; wherein said processor is further configured to receive a second user selected image which is selected from within said search results; receive a user selection of a second feature within said second user selected image; and wherein said search engine is further configured to repeat said searching and outputting steps based on said second selected feature.

The following features apply to one or more aspects of the invention.

Each feature may be a subsection of said user selected image, e.g. a chair within a picture of a room. The feature may be a shape, color, texture, pattern or other parameter of an object within said user selected image. There may be more than one feature selected from within each selected image. For example, a user selection of a first feature may be received from within said first user selected image and a user selection of a second and third feature may be received from within said second user selected image. The composite image may combine all three features.

At least one of said user selected images may be segmented into a plurality of objects which may be presented to a user, e.g. on a user interface. Said feature may be selected from one of said plurality of objects, e.g. by clicking on said object.

A weight may be applied to each selected feature when combining to form said composite image. Said weight may be adjusted by said user.

The invention further provides processor control code to implement the above-described systems and methods, for example on a general purpose computer system or on a digital signal processor (DSP). The code is provided on a physical data carrier such as a disk, CD- or DVD-ROM, programmed memory such as non-volatile memory (eg Flash) or read-only memory (Firmware). Code (and/or data) to implement embodiments of the invention may comprise source, object or executable code in a conventional programming language (interpreted or compiled) such as C, or assembly code. As the skilled person will appreciate such code and/or data may be distributed between a plurality of coupled components in communication with one another

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

Figure is a flowchart showing the steps of a method for selecting images;

FIG. 2a shows one application of the method of FIG. 1;

FIG. 2b shows an alternative application of the method of FIG. 1;

FIGS. 3a and 3b are representations of weighting which is an optional feature in the method of FIG. 1;

FIGS. 4a and 4b illustrate different ways of selecting an input image for the method of FIG. 1;

FIG. 5a is an illustration of a typical system for implementing the method, and

FIG. 5b is a screenshot showing an example of how the browser extension (with Google's Chrome browser) might be implemented.

### DETAILED DESCRIPTION OF THE INVENTION

This invention relates to a method and apparatus for searching for images, in particular the field known as CBIR (Content based image retrieval) or reverse image searching.

FIG. 1 shows the steps used in by the system to assist users in searching for images. The first step S100 is for a user to select an image to form the basis of the search. The user then specifies which feature(s) within the selected image are to be used in the search (step S102). The features may be one or more of color, coherence, pattern, texture or shape of an image, or a subsection of an image. The feature may be the whole image itself. Color coherence is a measure of the importance of the color within an image. For example, some red may be scattered (perhaps invisibly) through an image (say of a human face) and this would have a value for coherence that is less than an image containing a coherent block of red (say in a rose). These features may be used individually or in combination to refine the next round of search results.

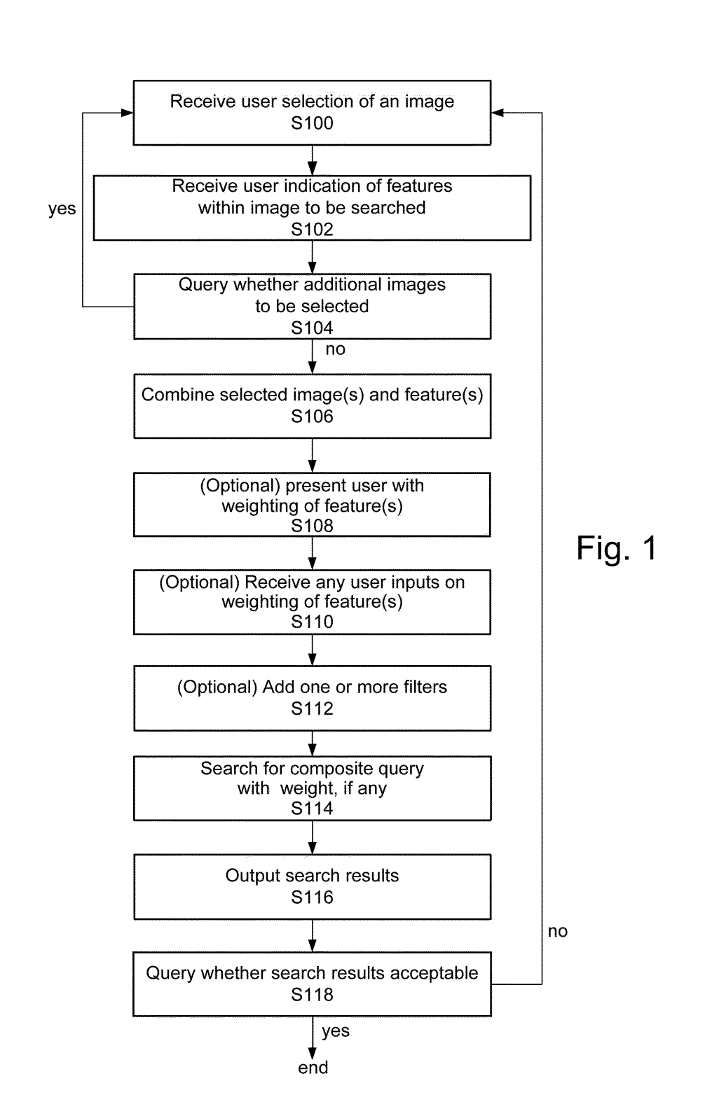

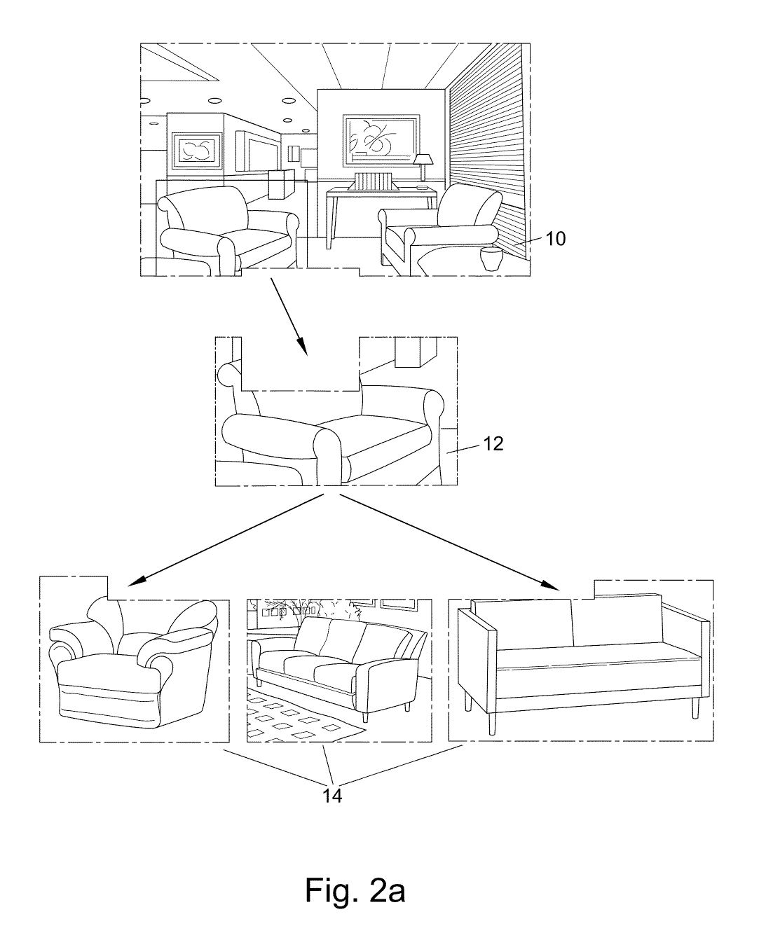

In order for the user of the system to specify which part of the image they are interested in, they need a mechanism for selecting parts of images. Examples of the kinds of selection methods that might be used include:
Rectangular selection boxes which are overlaid on the original image (as shown in FIG. 2a)
Polygonal (the user selects a number of points on the edge of the area they're interested in, and a polygon is created that joins those points)
Lasso (the user draws free-hand around the area they are interested in).
Automatic segmentation (in this case, the system automatically segments the image into a number of objects, and the user is able to simply click on one object (or more than one object) to indicate which one they are interested in).

The next step S104 is to consider whether or not other images are to be added into the search. If additional images are to be used, the method loops back to the first step and repeats the selection of the image and the selection of the feature within the image. If additional images are not to be used, the method combines the selected image(s) and feature(s) at step S106 to create a composite query which is searched. Creating the composite query may comprise creating a composite image made up of the selected image(s) or feature(s) but it is also possible to combine the selections without creating a composite image. This combination step may be termed ‘Clamp and Combine’. ‘Clamping and combining’ allows the user to select specific aspects of an image (for example its shape alone, or a combination of color and texture) which are then “clamped” into the search. This effectively filters the search results with multiple clamps, which when combined provide a more refined and useful end result.

As set out above, the feature(s) selected may be part of an image or a feature within the part. The user can indicate which features they want to search, and can combine that partial image with another (whole or partial) image. The user indication of the feature(s) within a (whole or partial) image(s) may be a textual description. For example, the user may say “I want to search for an image that has the color of this part of image 1 but the shape of this part of image 2”. Automated segmentation facilitates such selection. The segmentation would enable the user to select an object within an image (e.g. a car, a dress, a cat or a tree) by simply clicking on the object of interest. In this case, the system could optionally provide a textual description of the selected feature(s) and image(s), for example by displaying a message such as: “You have selected an image of a lady wearing a black dress”. The user indication could then be confirmation that the message is in line with their selection.

An improvement which is optionally included in the method is to add weight features according to how strongly the user would like to see those features displayed in the next round of search results. As shown at step S 108, these weights may be presented to a user. At step S110, user input on weighting is received. The user input may be in response to the presentation at step S108 or may be independently input.

Another optional improvement is to add domain filtering. At step S112, the user also has the ability to impose a structured domain filter on the image. For example, the user might select an image of a dress but restrict the search to the domain of skirts or curtains, to find a different type of item that is of the same color.

Once all the inputs are received, the search is carried out at step S114 and the results are output (step S116). A number of different algorithms may be applied for the searching itself. Examples include:

Color matching: comparing histograms of colors using chi-squared distance.

Shape matching: a method such as Histogram of oriented gradients (HOG: http://en.wikipedia.org/wiki/Histogram_of oriented_gradients)

Texture matching: a method such as that described by Haralick in his 1973 paper: http://dceanalysis.bigr.nl/Haralick73Textural%20features%20for%20image%20classifica tion.pdf

Pattern matching: matching larger-scale patterns such as stripes, dots, flowers and checks that appear on clothing and other products.

Each of the aforementioned references is incorporated herein by reference for all purposes.

In fact, the invention is not dependent on these specific methods: it could be deployed using a different set of algorithms for matching shape, color, pattern and texture, or indeed using algorithms for matching a range of other feature types (e.g. automatically extracted objects). Furthermore, the output of the searches may be a ranked list as is well known in the art. Alternatively, the output may not be ranked.

As an alternative for searching for matching results, an extension may be to generate new images at step S114. For example, the user may select an image of a dress and select the color green to form the composite image to the input to the system, i.e. the user might say “I'm looking for a dress like this, but in green”. The system would use its knowledge of images, objects, shape, color, pattern and texture to generate a new image that reflects that requirement. Similarly it might be asked to combine features from two or more images and use those to create a new image that reflects those combined features. This could, for example, be applied to icons: If a user has found a pair of icons, one of which has the color they are looking for and one which has the right shape, they might initiate a search using those selected features. If the search finds an existing icon that combines these features, this will be presented to the user, but in the case where no such icon exists, the system might generate a new icon which combines the selected features.

The results may just be the first round of the search process and thus a user is queried whether or not the search results are acceptable at step S118. If the user has found what they are looking for, no further searching is required and the process ends. Otherwise, the search results themselves may be used to form the basis of the next round of searching. This may be as simple as a user clicking on one of the images from the search in which case the method returns to step S100.

The selection (or non selection) of features effectively turns off or on a range of features (together or individually) as part of the search process. Thus it becomes possible for a user to provide non-linguistic, highly intuitive feedback to the image search engine. This is much more like the way humans naturally describe things to one another by pointing and showing, and saying ‘more like this bit’ or ‘similar to this shape’. By the iterative repetition of the search steps, a user can ‘steer’ their way towards a satisfactory end result, without needing to describe in words what they are looking for.

The method described here encourages a new way of searching for images via an evolutionary navigational process. In other words, a user might start with a query (e.g. a dress), narrow the search by specifying a particular feature (e.g. color), narrow the search further by combining this with a feature from another image (e.g. the texture of a shirt) and then navigate by clicking on the images that seem closest to the one they are looking for. Each click on an image starts a new search (possibly modulated by the elements included in the original search) and brings the user one step closer to what they are looking for. And when it doesn't, i.e., when it takes the user further from what they're looking for, they back-track and try again

FIG. 2a shows one application of the method of FIG. 1. The user selects an image and selects a feature (or more than one feature) from part of an image in accordance with steps S100 and S102 of FIG. 1. In this case, the user has found a photo 10 of a room, and they have selected the armchair 12 as being the item they are interested in basing the search on. In this implementation, no additional images are used and thus the combination step only has one input, the armchair. No weighting is applied but clearly the method could be optionally adapted to add weighting. Three different results 14 are returned by the search. Each of these results is a different armchair or sofa having similar color and style to the one selected. A user could then repeat the process with one or more of these search results.

FIG. 2b shows an alternative application of the method of FIG. 1 in which a user selects a feature (or more than one feature) from multiple images and combines them to form an item for searching. A user selects the shape 20 from a first image 30 (in this case a dress) image in accordance with steps S100 and S102 of FIG. 1. The user then decides to use additional images and method repeats steps S100 and S102 to select the color 22 from a second image 32 (in this case a different dress). Finally, in a third iteration, the pattern 24 from a third image 34 (also a different dress) is selected. In this case, the color and pattern have been selected from parts of the second and third images, rather than using the colors of the images as a whole, although the latter would also be possible. Accordingly, in this implementation, the features are shape, color and pattern together with a part of the image. The selected images and their features are combined to form a composite query. In this example, a composite image 28 having the selected shape 20, color 22 and pattern 24. No weighting is applied but clearly the method could be optionally adapted to add weighting. The composite image is used as the basis for the search.

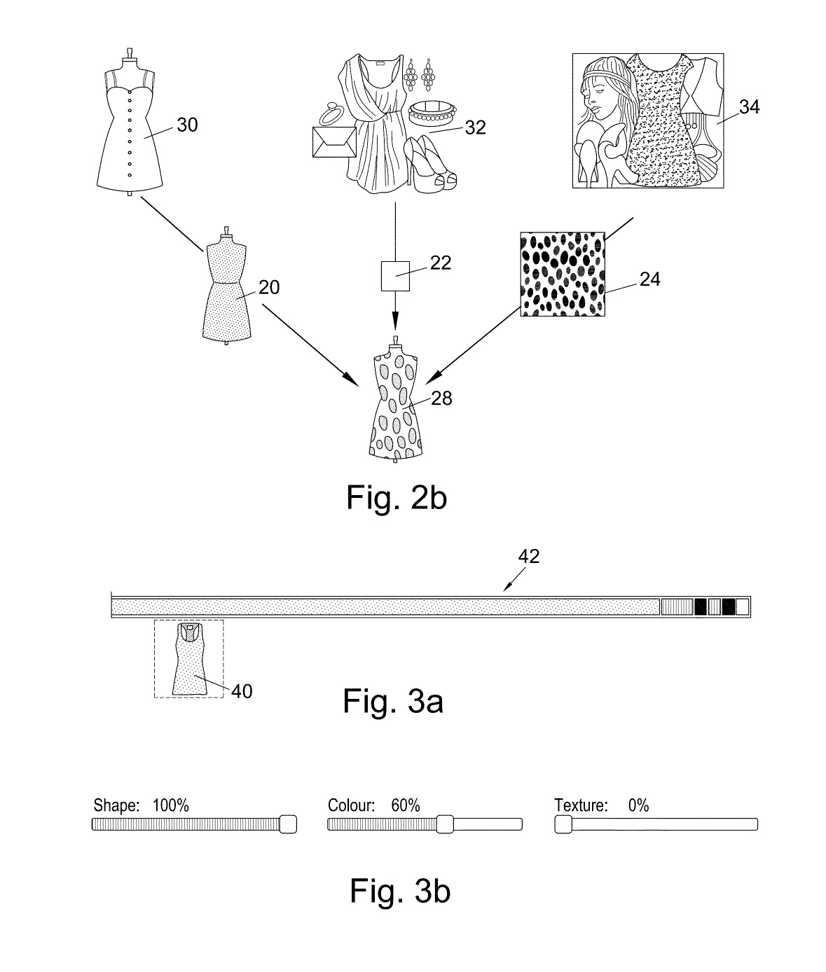

FIG. 3a illustrates one method of presenting a user with a weighting for a feature. For example, the user may be shown the colors that were identified in the image which forms the basis of the search. In this case, the image 40 selected is a dress, and the bar 42 above the image shows the relative weights of each color contained in the image. In this example, a bright red has the highest weighting with a first shade of black having the next highest weighting. The user can adjust the relative weights of the individual colors, for example, by dragging the divisions between the colors. Alternatively, a user can remove colors, for example by clicking on the color and selecting delete. Removal of the color shows that a user is not interested in this color, e.g. the black parts of this image. Finally, a user may be able to add in new colors. This may be done by a user inputting a textual description (e.g. “I'd like to find an item that is this shade of red, but with a bit of green added in as well”) or alternatively a menu could be provided (perhaps by clicking on the bar) to allow a user to select other colors.

The user may be shown the representation of FIG. 3a along with their search results. This may help a user to adjust the weighting to remove the results that they are not interested in. The representation of FIG. 3a may also be adapted to show other features which could be weighted for example as shown in FIG. 3b. The bar may show the weighting of the shape as well as the color and other features (e.g. texture) which enables a user to set the relative importance of each feature, e.g. to say that shape is more important than color which is more important than texture. A representation of the weighting of the color (or other feature) from each element forming the composite query may be shown. For example, where the composite query combines the colors of two images, a user may be able to show that the color of the first image is more important (and thus to be more highly weighted) than that of the second. This could be enabled through a set of sliders that the user can slide to set the relative weights.

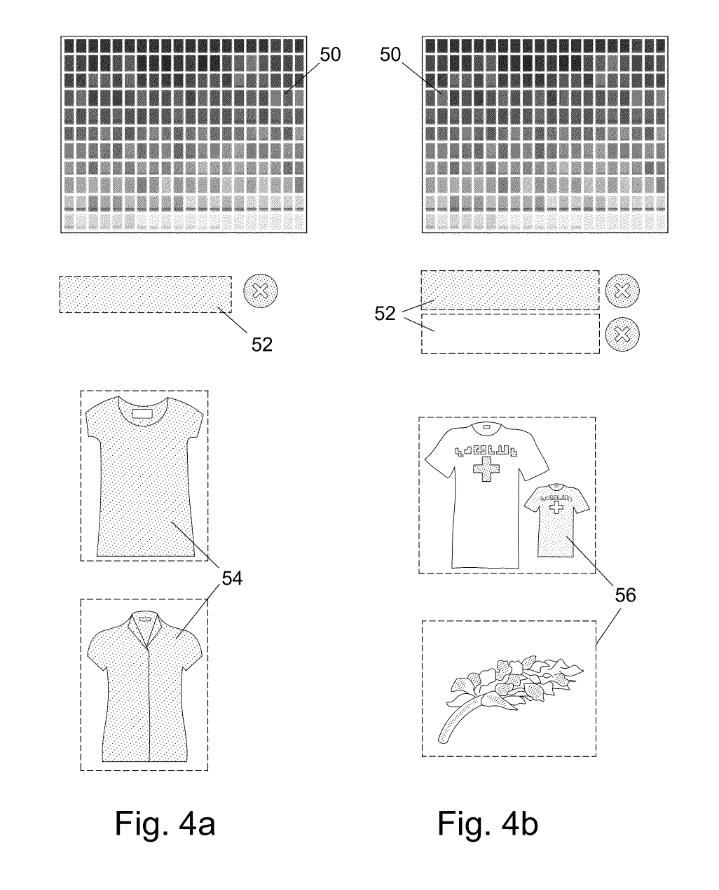

FIGS. 4a and 4b illustrate how the first step of the method of FIG. 1 may be completed. Thus step S100 which starts a search from an image may not be the first step in the process. As explained below, the user could start a search by selecting a color or more than one color:

In FIG. 4a, the user is presented with a color palette 50 comprising a plurality of colors. A user selects one color, e.g. by clicking on it and a bar 52 showing the selected color is presented to the user. A mechanism is also provided for a user to deselect the bar 52, in this case by clicking on the cross button. Once the color selection has been made, a user is shown images 54 that are largely made up of that single color. In FIG. 4b, the user has selected a second color (yellow) and is shown images 56 made up of those two colors in combination.

Thus, the first step S100 of FIG. 1 may be to select one (or more) of these images. The system preferably also provides a storage so that having identified images they are interested in, the user would have the ability to save those images (or parts of the images, or specific features of the whole or partial image) for future searches. Hence, the user might see a dress whose style they like, and could say “Find me dresses like this, but in the color of that pair of shoes I saved last week”.

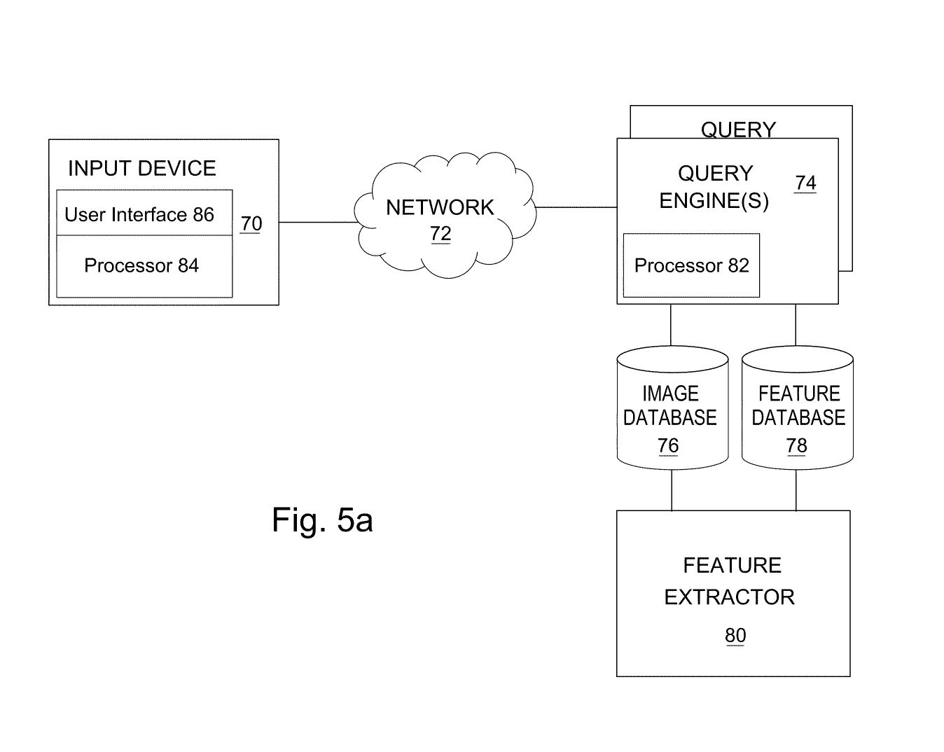

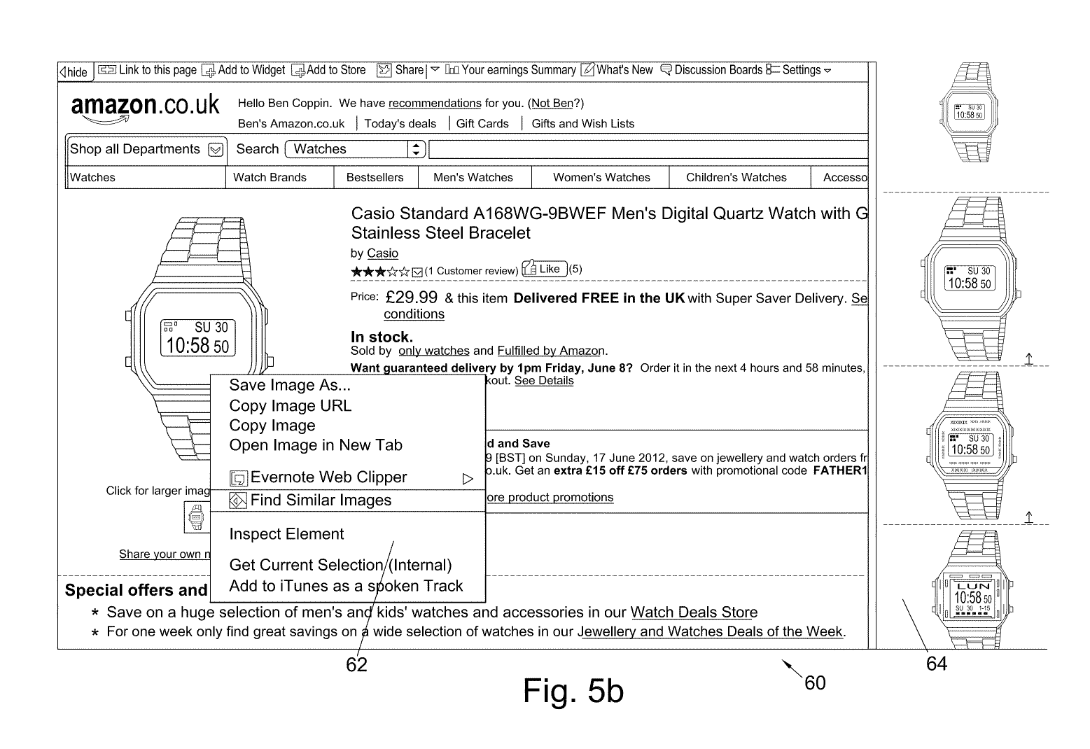

FIG. 5a shows a system in which the method may be implemented. The search service is deployed using the normal components of a search engine which includes at least one query engine 74 to prompt for and respond to queries from users. This system can be formed of many servers and databases distributed across a network, or in principle they can be consolidated at a single location or machine. The term search engine can refer to the front end, which is the query engine in this case, and some, all or none of the back end parts used by the query engine, whose functions can be replaced with calls to external services.

A user can make searches via the query engine using an input device 70. The input device may be any suitable device, including computers, laptops, mobile phones. The input device 70 is connected over a network 72, e.g. a wireless network managed by a network operator, which is in turn connected to the Internet via a WAP gateway, IP router or other similar device (not shown explicitly). Each input device typically comprises one or more processors 84, memory, user interface 86, e.g. devices such as keypad, keyboard, microphone, touchscreen, a display and a wireless network radio interface.

The processor 84 of the input device 70 may be configured to create the composite query which is sent to the query server 72 for searching. Thus the processor of the input device may be configured to receive a user selection of at least one image and at least one feature within each image, e.g. from the user interface on the input device 70. The processor 84 may then combine the selections, add any weighting or filters and send the composite query to the query server. Some or all of the steps in creating the composite query may be undertaken by the processor 82 of the query server. In this case, the processor of the query server may be configured to receive a user selection of at least one image and at least one feature within each image from the input device 70. The processor 82 may then combine the selections, add any weighting or filters and search for the resulting composite query. As explained above, the method provides a better query which initiates the search and thus when the query engine is enabling a user to the input this improved query, the query engine is effectively acting as a more efficient query server.

As shown in FIG. 5a, the query engine(s) 74 are connected to an image database 76 and a feature database 78. These are stores of images and features which can be presented to a user on the user interface of the input device 70 for selection. These databases can also be used to store images and features for individual users, for example, as explained with reference to FIGS. 4a and 4b. Both the image and feature databases 76, 78 are connected to a feature extractor 80. The feature extractor 80 takes images from the image database 76 and automatically segments them into individual features which are then stored in the feature database 78.

The query engine and other servers for conducting the search, e.g. servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

The method could be implemented in a number of forms, for example:
As a browser plug-in/extension. When a user views an image in a user interface 60 they are interested in, they could right-click on the image to reveal a context-sensitive menu 62. Within this menu would be an option to search for similar images. Having selected this, a side-bar 64 would appear showing similar images and providing further options. This is illustrated in FIG. 5b.
As a dedicated web site.
As an addition to an existing e-commerce site.
As a native app on a mobile phone or other hand-held device (and in this case it could be used to find similar objects to one contained in a photo taken using the device).

There are various applications for the described method. For example, with reference to FIG. 5b, the method could effectively provide an online shopping assistant. This enables people to search for items that they might otherwise find hard to find. One example of the mechanism might be a tool that a user can click on to indicate they are interested in finding other images similar to one they are viewing on a web page. This could have a commerce aspect: the user might be viewing a picture of a watch, and by clicking on the image they could be shown similar watches for sale, with links to sites (or a single site) selling similar watches.

Clearly, there is a more general application as a tool for helping people find interesting content. Like FIG. 5b, this could sit as a side-bar in the web browser, and as the user views a page, the side-bar would update with images similar to the ones on the page. Another application is as a tool to assist designers in finding images (photos, icons, drawings, etc.) that have appropriate colors, patterns or shapes for use in marketing material, web site design and other design elements.

The following describe examples for creating the composite image used as the search query:

1. A user is a casual shopper wanting to find some jewelry for his wife. He knows the kinds of things she likes, but have no idea what they have in common. He can recognise the right kind of thing, but has no idea how to describe it. Initially, he would select a random set of jewelry and would click on the one that was closest to what he was looking for, and would navigate from there.
2. A user is a shopper with a specific need for a replacement item of jewelry. The shape is like a polo (a circle with a hole in the middle) and the kind of material is quartz, maybe, or some crystalline pink-ish material. The composite image would be formed by selected an image and selecting the polo shape and by selecting an image and selecting the color pink. The user would navigate from there.
3. A user is a designer, looking for a good background image to go on a piece of marketing material. As shown in FIGS. 4a and 4b, the user could start by selecting the three main colors in the palette and navigate through the space of images until a suitable one is found. Ideally, the resulting image should fit with the color palette but not be too dominant in the picture.
4. A user is a casual shopper wanting to buy a coffee table for the lounge. The user uploads a photo of the lounge as the image to be searched. The results will return similar lounges, possibly with coffee tables. Once an image with a suitable table is returned, the user can select the table as the input to the search to find a place to buy that (or a similar) table.
5. A user is an art lover wanting to buy a painting that will look good in a room that already has two paintings. Photos of the two paintings are uploaded to form the composite image for the search. The search results will return other paintings with similar properties (color, texture, etc.) to those two.
6. A user is a casual shopper looking for a bed-spread that matches the curtains. A photo of my curtains as the image in step S100, and the user follows the other steps of the method.
7. A user is a casual window shopper who likes to browse the internet looking at things he might buy one day. Occasionally he'll buy something. Starting from a link sent by a friend, he is shown other similar items. Clicking on one of those items provides the image in step S100, and the user follows the other steps of the method.
8. A user is a house-buyer. He uploads a photo of a house he likes that is not for sale as the image in step S100. Features such as style, age, shape can be used to generate the composite image and a filter can be applied to generate results in the right area.
9. A user is a female shopper browsing the internet looking for new clothes. One day, she sees a dress she likes and clicks on the “I like this” button on the browser add-on. This triggers the searching by the system which returns a collection of similar dresses, and other types of clothing that have similar patterns and colors depending on the features and/or weighting applied by the user.
10. A user is a shopper who sees an architectural feature on a building. He uploads a photo of the feature to find an object for inside the home (a sculpture, a light-fitting etc.) that is similar in style.
11. A user is redecorating his house, and looking for a bath shower-tap thing that is similar in shape to an old-fashioned phone handset. The image in step S100 is a picture of a phone which can be combined with the shower category (either by filtering of using an image of a shower).
12. A user is building a web site and looking for an icon that will fit with my existing design. The composite image is built from an icon that has the right shape and another that has the right color palette. The search is thus initiated from these two icons.

No doubt many other effective alternatives will occur to the skilled person. It will be understood that the invention is not limited to the described embodiments and encompasses modifications apparent to those skilled in the art lying within the spirit and scope of the claims appended hereto.

1-13. (canceled)

14. A method of creating a search query comprising:
receiving a first user selected image via a user interface;
receiving a user selection of a first feature within said first user selected image;
receiving a second user selected image via the user interface;
receiving a user selection of a second feature within said second user selected image; and
combining said first and second user selected features to form a composite image to form the basis of a search query.

15-27. (canceled)
